(19) United States
(12) Patent Application Publication
(10) Pub. No.: US 2006/0046852 A1
(43) Pub. Date: Mar. 2, 2006

(54) Wide area gaming system

(76) Inventor: Richard Edward Rowe, Las Vegas, NV (US)

Correspondence Address: MARGER JOHNSON & MCCOLLOM, P.C., 210 SW MORRISON STREET, SUITE 400, PORTLAND, OR, 97204, US

(21) Appl. No.: 10/927,378

(22) Filed: Aug. 26, 2004

(51) Int. Cl. G06F 17/00; G06F 19/00

(52) U.S. Cl. 463/42

(57) ABSTRACT

A gaming network is comprised of a central gaming system and at least one gaming device to communicate with the gaming system using a wireless, packet-switched communications link. The gaming device has a communications to allow the device to communicate with a network, a processor to allow the device to provide gaming services, and an interface to allow the processor to communicate through the communications port with a wireless, packet-switched gaming network.

### BACKGROUND

Currently, gaming networks are generally based upon Publicly Switched Telephone Networks (PSTN), or digital services within the PSTN, such as Integrated Services Digital Networks (ISDN) and Digital Subscriber Lines (DSL). These networks may be a mix of individual Local Area Networks (LANs) using standard LAN technologies, such as those in compliance with Institute of Electrical and Electronic Engineers (IEEE) standard 802.3, also referred to as Ethernet. The LANs communicate with the larger, wide area gaming network.

Generally, these networks are employed to allow a centralized system to gather and transmit information to gaming machines spread across multiple sites with regard to accounting, event reporting, player tracking, etc. Typically, each site will have a site controller that collects information from each gaming machine. The site controller then communicates with the central system, and then may communicate information from the central system to the gaming machines at the site.

A particular gaming venue, such as a resort, may have multiple sites, and the gaming venue owner may have multiple gaming venues, each having their own multiple sites. This may result in one gaming venue having multiple site controllers arranged in a hierarchy, and then another level of the hierarchy responsible for communicating from each gaming venue to a central system. This requires extra hardware at each level, for each level site controller, as well as adding latency into the data path between the gaming machine and the central system.

### BRIEF DESCRIPTION OF THE DRAWINGS

Embodiments of the invention may be best understood by reading the disclosure with reference to the drawings, wherein:

FIG. 1 shows an embodiment of a current gaming network.

FIG. 2 shows an embodiment of a gaming network using wireless wide area networking.

FIG. 3 shows an embodiment of a local area network using wireless networking.

FIG. 4 shows an embodiment of a gaming machine having a wireless, packet switched communications module.

### DETAILED DESCRIPTION OF THE EMBODIMENTS

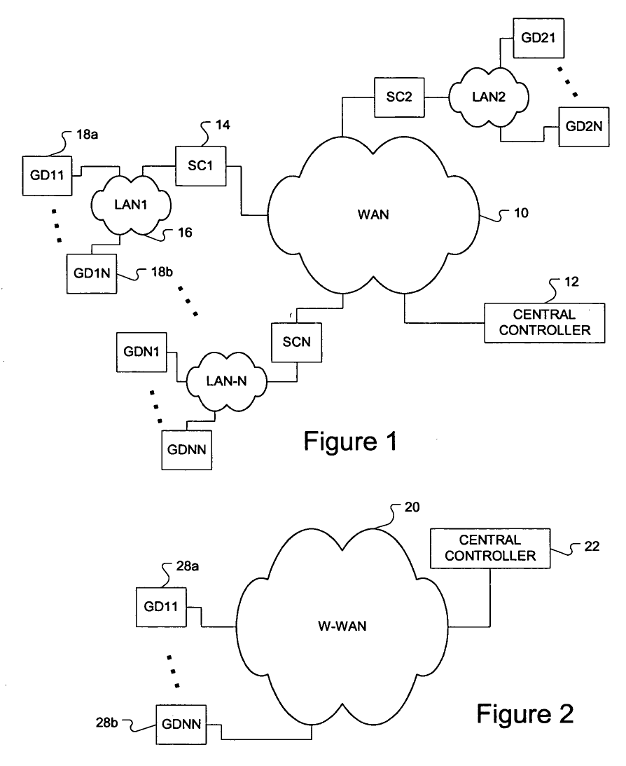

In FIG. 1, a typical gaming network is shown. The wide area network (WAN) 10 has residing upon it the central controller 12. The central controller manages the data collection and distribution in the WAN 10. This may include gathering accounting information from each game or each site, recording events, such as game outages, player tracking, etc. The data is collected and distributed to the central controller from each site controller, such as site controller SC1 14, connected to LAN1 16.

LAN1 has gaming devices GD11 18a through GD1N 18b. Each gaming device communicates across the LAN with the site controller, such as SC1. The site controllers than communicate with the central controller via the WAN. This results in latency in the data path, as the data has to travel the path between the gaming device and the site controller and then from the site controller to the central controller. Because of bandwidth and connection concerns, this has been the most practical way to implement this type of network.

For example, it may be possible to give each device its own wired connection to the WAN. However, this increases the cost of installing new devices, as they would each require their own cable connection to the WAN, rather than just to the LAN, as well as the bandwidth on the connection to allow all of them to communicate at the same time. It also decreases the LAN flexibility, as devices may not be as easily moved around within the LAN.

In addition, this network architecture requires an extra piece of equipment at each site. It is possible that each site may have sub-site controllers. Each site controller, instead of talking only to gaming devices directly connected to it, may have site controllers of smaller LANs connected to it. For example, the gaming device GD11 could be replaced with a site controller SC11 that is managing a LAN that is then connects to LAN1 through a site controller. While this may make traffic and connections more manageable, it increases the latency in the data path as well as adding another piece of equipment to the network.

It must be understood that adding another piece of equipment to the network may not be another physical piece of equipment. There may already be a device on a LAN that is functioning as another type of device, in which a logical partition is provided to perform the function of a site controller. Regardless, the network would have another device on it, and the resources of the device providing the functionality are absorbed in the site controller functionality.

With the advent of packet-switched wireless networks, the network architecture can be simplified with elimination of the site controllers, without addition of extra cable connections. An example of a packet-switched, wireless network is GPRS (General Packet Radio System). The use of packet-switching, prevalent in wired networks, in wireless networks has alleviated the need for connection-oriented networking and allows data to be moved more easily through the wireless network to its destination.

Current cellular networks typically used circuit-switching. In circuit-switching, a call set up establishing a circuit between the caller and the party called. This reserves the paths between the caller and the party called, causing a load on the network. In packet-switching networks, such as the Internet, the data is packetized into discrete ‘bundles’ of data. Each packet is transmitted through the network, some packets going one route, others taking another route, depending upon whichever path is the fastest at each routing device in the network.

One problem with packet-switching is that the packets may arrive at the destination out of order. For real-time data, where the data has to be received in a particular order to make sense, this can be a problem. Technology and network management techniques have evolved to a point in which there are solutions to this problem.

A packet-switched wireless network treats the data from a wireless call like a data packet in a packet-switched network. Safeguards and quality measures are used to ensure that the packets arrive at the destination quickly and in the proper order. Examples of packet-switched wireless networks include GPRS, third generation (3G) and fourth generation (4G) networks.

First generation networks were analog, circuit-switched networks. Second generation networks are digital, personal cellular service (PCS) networks. GSM (Global System for Mobile Communications), a standard growing in popularity, is sometimes referred to as generation 2.5, as is GPRS. These are generally packet-switched standards, although they accommodate circuit-switched calls as well. 3G networks, defined by a standard from the International Telecommunications Union (ITU), are back-compatible to 2G networks, but they employ packet-switching, as does 4G networks.

The use of a packet-switched wireless network allows the network architecture of FIG. 1 to be simplified to the network architecture of FIG. 2. The WAN 10 from FIG. 1 has been replaced with the wireless wide are network (W-WAN) 20. The central controller 22 is connected to the W-WAN, most likely at the gaming headquarters, but could be anywhere on the W-WAN. The central controller 22 may be referred to as a central gaming system. The individual gaming devices, such as GD11 28a and GDNN 28b are gaming devices with a wireless network adapter attached to them, or integrated within them. The wireless network adapter allows them to communicate using a wireless, packet-switched communications link, such as GPRS, 3G or 4G.

The central controller 22 can continue to perform its usual functions of data collection, accounting, etc., but with data directly from the machine. While there may be some latency in the data arriving at the central controller, it is believed that the safeguards in place for quality assurance in the wireless, packet-switched network will result in less latency than the previous hierarchy. In addition, the site controllers have been eliminated.

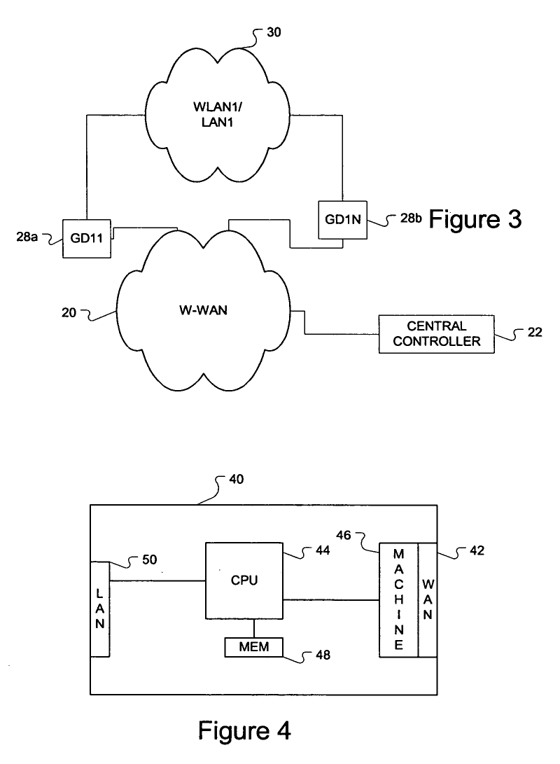

While the gaming devices may be connected directly to the WAN, they may also be connected, wired or wirelessly, to their LAN for local communications, events and management of a particular venue. This is shown in FIG. 3. There may be some local data, such as local content, that is shared by devices local to a particular site, connected by a LAN 30, which does not need to be sent to the central controller 22. The addition of wireless adapters to each gaming device may also allow them to act as peers, without participating in either the LAN or the W-WAN. LAN 30 may be a wired LAN or a wireless LAN.

An embodiment of such a device is shown in FIG. 4. The device 40 has a communications port 42 to allow the device to communicate with a network, a processor 44 to allow the device to provide gaming services and manage communications, and an interface 46 to allow the processor to communicate through the communications port with a wireless, packet-switched gaming network, such as GPRS, 3G or 4G. As mentioned above, the device may also have a local communications port 50 to allow the device to communicate with a local area network. There may not be a need for a second port, if the LAN is a wireless LAN, as the device may be able to use the same port for both. The device may also include a memory 50 for storage of various instructions, gaming content, etc.

Returning to FIG. 2, it can be seen that establishing a gaming network is much simpler than in implementations prior to this invention. The gaming device or the central gaming system 22 establishes a communications link with the other device, where the link is a packet-switched, wireless link. The two devices can then exchange data between themselves. The data exchanged between the gaming devices and the controller can be grouped as to whether it is traveling to the gaming device, or being transmitted from the gaming device.

Data coming from the gaming device may include accounting meter data; event data signifying such things as a door open on the machine, tickets are low, etc.; technician information, such as which technician performed what service when; game signatures used to determine validity; and requests such as ticketless/cashless transaction validation requests. Data being transmitted to the gaming device may include configuration information such as denomination of payouts, pay tables, game number, etc.; enable signals to turn the game on or off; signature requests to being calculation of program signature for verification; and responses to requests, such as a response to a validation request. These are only examples of the types of data, and there is no limitation intended nor should be implied from these examples.

As the data will be traveling via radio, ‘in the air,’ it may be advisable to provide encryption for the data. Encryption may be implemented in many ways, including password access, private/public key exchange, trusted platform tokens, etc. The data exchange could be goverened by many different protocols within the packet switching aspect of the wireless network. Packet transport protocols include the Transfer Control Protocol (TCP), User Datagram Protocol (UDP), etc.

Thus, although there has been described to this point a particular embodiment for a method and apparatus for a wireless, wide area gaming network, it is not intended that such specific references be considered as limitations upon the scope of this invention except in-so-far as set forth in the following claims.

What is claimed is:

1. A gaming network, comprising:
a central gaming system; and
at least one gaming device to communicate with the gaming system using a wireless, packet-switched communications link.

2. The gaming network of claim 1, the network comprising at least one local area network to which the gaming device is connected.

3. The gaming network of claim 1, the central gaming system further comprising a data collection system.

4. The gaming network of claim 1, the central gaming system further comprising an accounting system.

5. The gaming network of claim 1, the gaming device further comprising a video lottery gaming device.

6. The gaming network of claim 1, the communications link further comprising one selected from the group comprised of: a general packet radio system link, a third generation link and a fourth generation link.

7. A gaming device, comprising:
a communications port to allow the device to communicate with a network;
a processor to allow the device to provide gaming services; and
an interface to allow the processor to communicate through the communications port with a wireless, packet-switched gaming network.

8. The gaming device of claim 7, the gaming device further comprising a local communications port to allow the device to communicate with a local area network.

9. The gaming device of claim 7, the gaming device further comprising memory to allow the device to store data.

10. The gaming device of claim 7, the interface further comprising a general packet radio system interface.

11. The gaming device of claim 7, the interface further comprising a third generation interface.

12. The gaming device of claim 7, the interface further comprising a fourth generation interface.

13. The gaming device of claim 7, the interface further comprising a fourth generation interface.

14. A method of communicating across a gaming network, comprising:
establishing a wireless, packet-switched radio communication link from a gaming device to a central controller; and
exchanging data between the gaming device and the central controller.

15. The method of claim 14, establishing a wireless, packet-switched radio communication link further comprising establishing a general packet-switched radio system communications link.

16. The method of claim 14, exchanging data further comprising transmitting data from the gaming device to the central controller, wherein the data is one of the group comprised of: accounting meter data, event data, player information, technician information, game signature, and validation requests.

17. The methods of claim 14, exchanging data further comprising sending data from the central controller to the gaming device, wherein the data is one of the group comprised of: configuration data, enable signal, disable signal, signature request, and validation responses.

18. The method of claim 14, establishing a wireless, packet-switched radio communications link further comprising establishing a secure link.

19. The method of claim 18, exchanging data further comprising exchanging encrypted data.
